(19) United States
(12) Patent Application Publication
(10) Pub. No.: US 2011/0258067 A1
(43) Pub. Date: Oct. 20, 2011

(54) ONLINE MARKETPLACE FOR INFORMATION AND INTANGIBLE GOODS

(76) Inventor: Michael Rowell, Medina, WA (US)

(21) Appl. No.: 13/086,999

(22) Filed: Apr. 14, 2011

Related U.S. Application Data
(60) Provisional application No. 61/324,152, filed on Apr. 14, 2010.

(51) Int. Cl. G06Q 30/00

(52) U.S. Cl. 705/26.2

(57) ABSTRACT

A system and methods to enable a plurality of vendors of information to sell that information to a plurality of consumers of information are disclosed. The information may include sales leads, such as sales leads for potential sales of insurance products. The disclosed system may enable a plurality of users to provide standing orders for information, including defining a plurality of parameters or filters. The system applies these parameters to information offered for sale by the vendors, and automatically delivers information that satisfies the parameters. The system may enable the user to define when to purchase information, such that information offered for sale during a time the user cannot use it is not purchased. The disclosed system may therefore provide an online marketplace that enables a plurality of different users to purchase information sold by a plurality of different vendors in an easy and consistent way.

### COPYRIGHT NOTICE

A portion of the disclosure of this patent document contains material that is subject to copyright protection. The copyright owner has no objection to the photocopy reproduction of the patent document or the patent disclosure in exactly the form it appears in the Patent and Trademark Office patent file or records, but otherwise reserves all copyright rights whatsoever.

### TECHNICAL FIELD

The present disclosure relates in general to a system and method for facilitating the distribution of information in an online setting. More specifically, the present disclosure relates to a system and method for establishing a web-based sales lead marketplace and for distributing sales leads to salespeople using the online sales lead marketplace.

### BACKGROUND

Sales people are frequently faced with the problem of establishing wider audiences of potential buyers of products or services. For example, if an insurance sales person wishes to be successful, that sales person may expand his or her sales by repeatedly reaching out to new potential buyers of insurance. This arrangement exists for sellers of many other kinds of property, both tangible and intangible.

One source or pool of potential buyers may result from what are known as sales leads. Each sales lead contains a small amount of information identifying a potential buyer. For example, a sales lead may indicate a buyer's name, address, telephone number, and/or occupation. In addition, a sales lead may include information indicating a quality of the sales lead—that is, information indicating how likely the individual referenced by the lead is to purchase a certain kind of product.

Certain vendors distribute sales leads to sales people. These vendors may sell such leads on a per-lead basis, such as by charging a sales person a flat fee for each lead sold. Upon receiving such a lead, the lead vendor may send the lead to the sales person, enabling the sales person to contact the individual identified in the lead and attempt to make a sale.

Currently, lead vendors and sales staffs lack a convenient, effective way to distribute and obtain sales leads, respectively. Moreover, sales staffs lack a mechanism by which to purchase leads from multiple vendors simultaneously and seamlessly. Sales staffs also lack a mechanism that enables them to track the quality of purchased leads, such as by tracking and generating reports about those leads that resulted in sales. Sales staffs also do have a mechanism by which to precisely schedule the delivery of sales leads, such that leads are delivered when the sales staffs will be utilizing them, and will not be delivered when sales staffs are unavailable or depleted. Finally, sales staffs lack a system that enables social networking within the sales community through the distribution of sales leads.

Further drawbacks with current sales information distribution systems, such as lead distribution systems, include the fact that pricing for such information is static and does not indicate changing market and purchaser conditions. Quality of the purchased information is neither consistent, nor is it reflected in the price ultimately paid for the information by the consumers of the information. Present systems also lack controls over volume, price, quantity, and basic Return on Investment (“ROI”) reporting. Finally, presently available systems can frequently result in a substantial amount of undersold and unsold inventory of intangible property.

Accordingly, there is a need for a new system and method for implementing an online marketplace for distributing sales leads, intangible property, or other information, which enables vendors and sales staffs to interact in a convenient, reliable way, and which enables vendors and sales staffs to track the results of property sold through the distribution system.

### SUMMARY OF THE DISCLOSURE

Various embodiments of the information distribution system disclosed herein enable distribution of information, such as sales leads, to consumers of that information, such as a sales staff, in a customized way. The disclosed system enables information vendors to provide inputs to the system (i.e., information for sale), and enables information consumers to retrieve the information (i.e., purchase the information) based on numerous criteria associated with those consumers.

One embodiment of the disclosed system is a system for distributing sales leads, such as insurance sales leads, to a sales staff. In this embodiment, the disclosed system enables sales people to request and receive leads from a plurality of lead vendors based on criteria established by either the sales staff or the vendors. Further, this embodiment of the disclosed system enables the sales staff to provide information indicative of a payment mechanism, such as a credit card, so that the leads can be sold to the sales staff.

The disclosed system also enables reporting to be provided by either the vendors of the information or feedback of the consumers of the information, such that the quality of the vended information can be tracked. The disclosed system may enable consumers of distributed leads to rate various aspects of their interaction with the disclosed system. For example, consumers may be able to rate their purchase experience with sales people, the ease of use of the disclosed system, the quality of the leads individually, or the quality of the leads overall. Likewise, the disclosed system may enable the sales people consuming the leads to provide feedback about the ultimate result of the lead—for example, whether the lead resulted in a sale or not.

The disclosed system may also enable sales people to purchase leads from multiple vendors without worry that the leads will be duplicative. That is, if two different lead vendors each try to sell the same lead, the disclosed system may ensure that a single sales person only purchases that lead once.

In one embodiment, the disclosed system facilitates an online marketplace wherein buyers can set the prices they are willing to pay for leads, and sellers can elect to provide leads at the indicated price. For example, if a sales person indicates that he or she wishes to purchase fifteen (15) leads for ten dollars ($10.00) each, the disclosed system enables a vendor to decide whether to provide the requested leads in exchange for the indicated price.

One embodiment of the disclosed system may be viewed as or integrated with a consumer relationship management (“CRM”) system and/or may be integrated with an existing CRM system. In such an embodiment; the system automates some or all of the workflow associated with the distribution of leads to sales staffs, integrates and makes available historical data based on past sales activity, and/or provides marketing information pertinent to the leads being distributed by the disclosed system.

The disclosed system may further facilitate the delivery of information such as sales leads to individual members of sales staffs by using various delivery mechanisms. For example, the disclosed system may enable the distribution of sales leads and other pertinent information to sales people by way of email, internal or external web pages, telephone, mobile device text messaging, or other appropriate distribution mechanism.

In one embodiment, the disclosed system is configured to operate with one or more advertising platforms to display information to individuals representing leads at the time those individuals provide information. For example, if an individual enters his or her information (such as telephone number, name, address, etc.) into a web-based form, the disclosed system may include or interact with an advertising system that displays pertinent information to the individual at the time of data entry.

It is therefore an advantage of the present disclosure to provide a system that enables the flexible purchasing, transferring, exchanging, and management of sales leads. It is a further advantage of the instant system to provide reliable tracking and lead management tools to enable purchasers and sellers of leads alike to track the quality, success, and utility of the leads being sold and purchased within the system.

Another advantage of the present disclosure is to provide a system in which a sales force can be provided with incentives by rewarding sales activity with additional leads. It is similarly and advantage of the present disclosure to provide a system which facilitates the creation of a social networking feel for the purchase, exchange, and use of sales lead information.

Additional features and advantages are described in, and will be apparent from, the following Detailed Description and the figures.

### BRIEF DESCRIPTION OF THE FIGURES

FIG. 1 is a block diagram showing one example of a host device architecture for implementing the information distribution system disclosed herein.

FIG. 2 is a flow diagram illustrating exemplary process flows facilitated by one embodiment of the information distribution system disclosed herein.

FIG. 3 is a block diagram of an example architecture of lead vendors, sales agencies, and sales agents facilitated by the system disclosed herein.

FIGS. 4, 5, 6, 7, and 8 each illustrate an exemplary schematic of a screen that is displayed to a purchaser of leads accessing the disclosed system to place a lead order.

FIG. 9 is an exemplary schematic of a screen that is displayed to a purchaser of leads to enable the purchaser of leads to manage outstanding lead orders.

FIG. 10 is an exemplary schematic of a screen that is displayed to a user of the disclosed system to enable the user to enter profile information and manage the funds available for the purchase of leads.

### DETAILED DESCRIPTION

In one embodiment, the information distribution system disclosed herein facilitates the creation of an online marketplace for intangible information, such as sales leads in the insurance industry, from one or more sellers of leads to one or more consumers of leads. The disclosed system facilitates such an online marketplace to enable sales leads to be purchased in real time. The online marketplace facilitated by the disclosed system is flexible both in its ability to enable prices of intangible information, such as leads, to change based on supply and/or demand changes, and in its ability to make customized sets of intangible information available to purchasers of that information. In addition, the disclosed system provides a single source for both intangible information sellers and purchasers, in which a plurality of sellers can make their information available for purchase by a plurality of purchasers easily and flexibly. It also enables information purchasers to purchase information at prices they wish to pay, rather than being forced to pay a price designated solely by a single seller of information. Moreover, the disclosed system facilitates the formation of relationships between individuals involved with the sales leads. For example, a user of the disclosed system can place an order for (and pay for) leads that are delivered to another individual. The system therefore advantageously provides its users with a way to place an order for sales leads, and to receive those sales leads as they become available, according to certain filters and parameters specified by the user, in an online marketplace setting.

Various embodiments discussed herein pertain specifically to the distribution of sales leads from sellers of information to consumers of information. Moreover, certain embodiments discussed herein enable a user to place an order for sales leads, and to cause those purchased sales leads to be delivered to another individual. It should be appreciated that despite such discussion, the instant disclosure is not intended to be limited to the distribution of sales leads. Indeed, the system disclosed herein could be used to distribute any kind of information to a plurality of consumers of the information. Moreover, although sales leads are typically distributed to only one consumer of the lead, the disclosed system could be advantageously applied in an environment wherein a plurality of consumers can consume the same set of information while still retaining its beneficial characteristics.

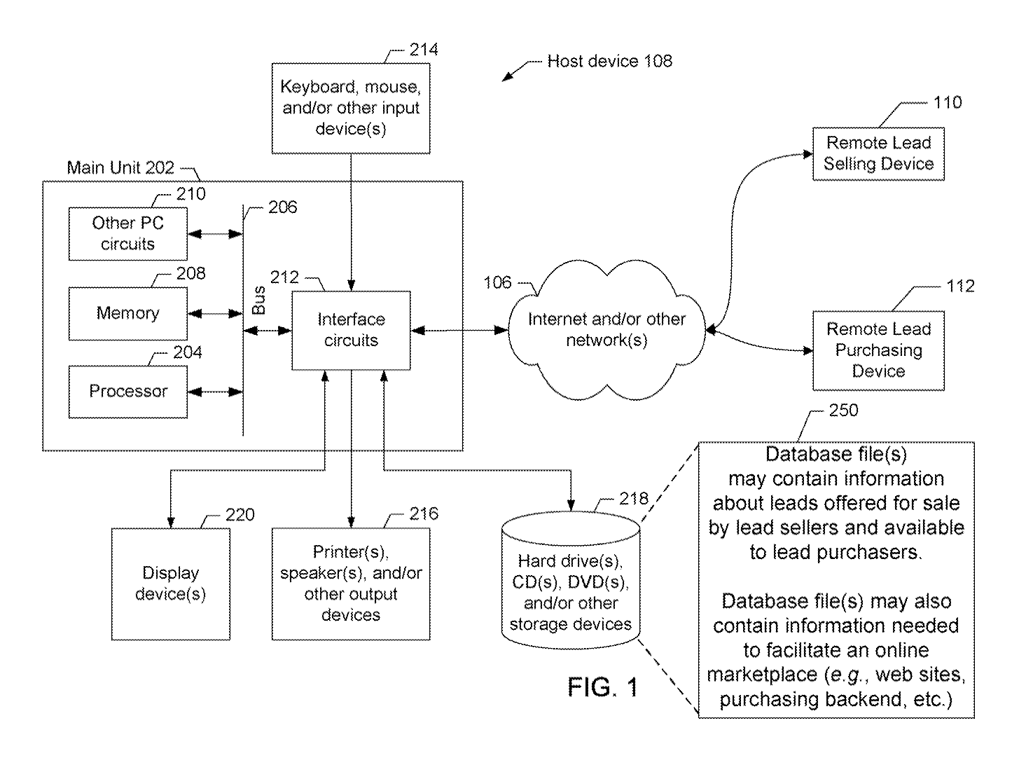

FIG. 1 is a block diagram illustrating an example of the electrical systems of a host device (e.g., host device 108) usable to implement the information distribution system disclosed herein. In one embodiment, the host device 108 corresponds to a lead distribution system whose functions and capabilities will be discussed in more detail below.

In the example architecture illustrated in FIG. 1, the host device 108 includes a main unit 202 which preferably includes one or more processors 204 electrically coupled by an address/data bus 206 to one or more memory devices 208, other computer circuitry 210, and one or more interface circuits 212. The one or more processors 204 may be any suitable processor, such as a microprocessor from the INTEL PENTIUM® family of microprocessors. PENTIUM® is a trademark registered to Intel Corporation and refers to commercially available microprocessors.

In one embodiment, host device 108 includes memory 208. Memory 208 preferably includes volatile memory and non-volatile memory. Preferably, the memory 208 stores one or more software programs that interact with the other devices in the system as described below. In addition or alternatively, these programs may interact with one or more vendor devices and one or more user devices to facilitate the sale and distribution of leads as discussed below. These programs may be executed by the processor 204 in any suitable manner. The memory 208 may also store digital data indicative of intangible information, such as sales leads, documents, files, programs, web pages, etc. received from remote lead selling device 110, remote lead purchasing device 112, or some other appropriate source.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays 220, printers, speakers, and/or other output devices 216 may also be connected to the main unit 202 via the interface circuit 212. The display 220 may be a cathode ray tube (CRT), liquid crystal display (LCD), or any other type of display. The display 220 generates visual representations of data during operation of the host device 108. For example, the display 220 may be used to display a representation of at least a portion of one or more pieces of information, such as one or more sales leads, offered for sale by a user at remote lead selling device 110 or desired to be purchased by a user at remote lead purchasing device 112. Alternatively or in addition, the display 220 may be utilized to display reporting or other statistical information about the sales activity facilitated by host device 108.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the host device 108. In one example described in more detail below, the storage device 218 stores database information including web site data, lead order data, lead data (either about presently-available leads or previously sold leads), and/or other information required to facilitate the offer for sale and purchase of leads by the users at remote lead selling device 110 and remote lead purchasing device 112, respectively. Further, the storage device 218 may also include database files that contain information needed to facilitate the online marketplace disclosed herein, such as web site information, purchasing software including software to enable a user to bid on a lead and/or complete a transaction (e.g., by providing credit card information) and the like.

In one embodiment, the host device 108 exchanges data with both the remote lead selling device 110 and the remote lead-purchasing device 112. In a further embodiment, the disclosed system enables a plurality of remote lead selling devices, such as device 110, and a plurality of remote lead purchasing devices, such as device 112, to communicate with the host device 108 such that information can be exchanged by and between users at each of those devices. For example, as discussed in detail below, the host device 108 may enable a user at a remote lead purchasing device 112 to specify a lead order. The host device 108 may thereafter interact with one or more remote lead selling devices 110 to determine which leads (if any) satisfy the user's lead order. If any leads satisfy the user's specified lead order, the host device 108 may facilitate the delivery of the leads to the user who placed the lead order.

Preferably, this connection of devices (i.e., the host device 108, the remote lead selling device 110, and the remote lead purchasing device 112) is facilitated by a network connection over the Internet and/or other networks, illustrated in FIG. 1 by cloud 106. The network connection may be any suitable network connection, such as an Ethernet connection, a digital subscriber line (DSL), a WiFi connection, a cellular data network connection, a telephone line-based connection, a connection over coaxial cable, etc.

Access to a host device 108, remote lead selling device 110, and/or remote lead purchasing device 112 may be controlled by appropriate security software or security measures. An individual user's access can be defined by the host device 108 and limited to certain data and/or actions. Accordingly, users of the system may be required to register with one or more host devices 108, remote lead selling devices 110, and/or remote lead purchasing devices 112 prior to engaging in the lead purchasing and management activities facilitated by the disclosed system.

In a preferred embodiment, each of the remote lead selling devices 110 and remote lead purchasing devices 112 has a similar structural makeup to that described above with respect to the host device 108. That is, each remote lead selling and remote lead purchasing device in on embodiment includes a display device, at least one input device, at least one memory device, at least one storage device, at least one processor, and at least one network interface device. It should be appreciated that by including such components, which are common to well-known desktop, laptop, or mobile computer systems (including smart phones, tablet computers, and the like), remote lead selling devices 110 and remote lead purchasing devices 112 facilitate interaction among and between each other by users of the respective systems.

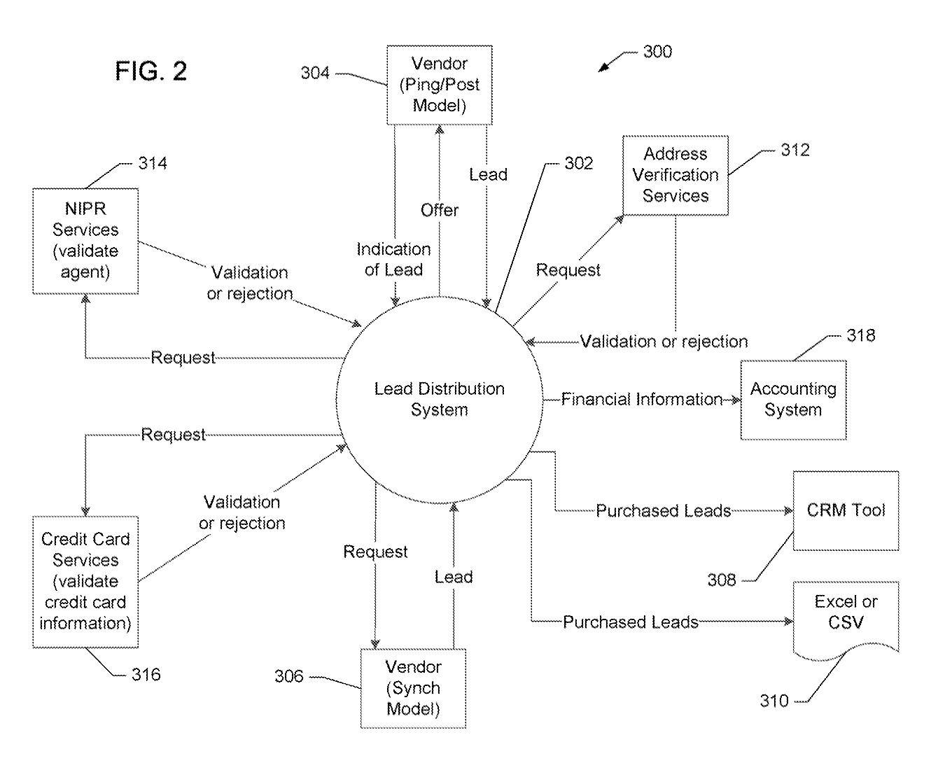

FIG. 2 is a flow diagram 300 illustrating exemplary process flows facilitated by one embodiment of the information distribution system disclosed herein. In the embodiment illustrated in FIG. 2, the various process flow operations are facilitated by the Lead Distribution System 302 at the center of the flow diagram 300. It should be appreciated that the flow diagram 300 of FIG. 2 is an exemplary flow diagram illustrating a plurality of process flows. In other embodiments, additional or different flows are possible consistent with the remainder of the instant disclosure.

In one embodiment, the Lead Distribution System 302 illustrated in FIG. 2 represents a functional description of host device 108 illustrated and discussed above with respect to FIG. 1. That is, the host device 108 in this embodiment performs the tasks specified in FIG. 2 as being performed in the Lead Distribution System 302.

In this embodiment, one or more of the blocks 304, 306, 308, 310, 312, 314, 316, or 318 represent a functionality performed by the host device 108, remote lead selling device 110, remote lead purchasing device 112, or some other device or system not illustrated in FIG. 1. The specific roles, and which (if any) of host device 108, remote lead selling device 110, and remote lead purchasing device 112 in the illustrated blocks correspond to, is discussed in more detail below. Further, as appropriate, the discussion of FIG. 2 that follows includes a discussion of external systems, not illustrated in FIG. 1, that perform some of the functionality of FIG. 2.

Referring first to block 304, a process flow is illustrated in which leads are delivered from a vendor to the Lead Distribution System 302 (and eventually to a purchaser) based on a ping/post model. In FIG. 2, block 304 illustrates a functional representation of the vendor in the ping/post model, and corresponds to a remote lead selling device such as remote lead selling device 110 illustrated in FIG. 1. In the illustrated flow, a vendor of leads 304 is responsible for informing the Lead Distribution System 302 that one or more leads are available for potential purchase and consumption. In this embodiment, the availability of the leads from the vendor represented by block 304 is based on a ping/post model. Under such a model, when the vendor 304 has a lead it wishes to make available to the Lead Distribution System 302, the vendor pings the Lead Distribution System 302, indicating that the lead is available. In one embodiment, a subset of information about the lead, such as its quality or a location of an individual to whom the lead refers, is included in the pinged indication of the lead.

In one embodiment, the vendor provides information indicative of the read to the Lead Distribution System 302 without providing any personal contact information. In one embodiment, a distribution directive of the lead is distributed with the initial lead information, enabling the disclosed system to determine how many times the lead has been sold and the remaining number of times the lead can be sold. Thus, the information in the originally-provided lead is demographic in nature. Upon receipt of an indication that the lead has been purchased, the vendor provides the lead with the requisite personal information, enabling a sales person to contact the individual associated with the lead.

Upon receiving the ping indicating that a lead is available to the Lead Distribution System 302, the Lead Distribution System 302 applies the lead orders it is managing to determine whether such lead satisfies any of the pending orders. As will be discussed below, these lead orders are provided to the Lead Distribution System 302 via a plurality of purchasers at remote lead purchasing devices 112. If the Lead Distribution System 302 determines that the lead satisfies one or more standing lead orders, the Lead Distribution System 302 sends a return message to the vendor 304 indicating that a purchaser has made an offer for the lead. In response to the offer, the vendor 304 posts the lead to the Lead Distribution System 302 for delivery to the purchaser or purchasers whose orders are satisfied by the lead.

It should be appreciated that when this mechanism of lead delivery is relied on, the vendor 304 initiates communication with the Lead Distribution System 302 for delivery of any leads available to it. The Lead Distribution System 302 receives the ping, and determines whether the offered lead is responsive to any standing lead orders maintained and implemented by the Lead Distribution System 302.

In an alternative lead delivery embodiment illustrated in FIG. 2, functionality of the lead vendor is illustrated as block 306. In this embodiment, the Lead Distribution System 302 initiates communication with the vendor 306. Specifically, as illustrated, the Lead Distribution System 302 sends a request to the vendor 304. For example, the Lead Distribution System 302 may send a request to the vendor including a number of desired lead criteria, such as a desired type of product for a lead and a desired price for the lead. The vendor 304 awaits the request, and upon receipt of the request, sends a responsive message including the lead. For example, if the vendor has a lead available that satisfies the provided request, the vendor responds affirmatively to the request from the Lead Distribution System 302. In this embodiment, the vendor 306 delivers leads on demand, and the Lead Distribution System 302 takes a more active role in that it initiates communications with the vendor 306.

In the illustrated embodiment, after the lead is purchased, the Lead Distribution System 302 delivers the lead to the purchaser. In terms of the illustrated embodiments, blocks 308 and 310 represent this delivery of leads.

Block 308 of FIG. 2 represents a delivery of leads to a consumer relationship management, or CRM, system. In one embodiment, such a CRM system is a system maintained by an entity with a sales force, and enables the sales force to consume information in an organized way via the CRM system. For example, the CRM system may be implemented by the remote lead purchasing system 112 illustrated in FIG. 1, and may enable a plurality of salespeople to access data within the CRM system. In this embodiment, it should be appreciated that the Lead Distribution System is responsible for facilitating the lead distribution marketplace, and the CRM system enables sales people within the purchasing organization to consume those leads.

In another embodiment, the disclosed system delivers leads to the purchaser of the leads directly. For example, as illustrated in FIG. 2, the Lead Distribution System 302 may deliver leads directly 310 as an Excel® file, a comma-separated values or CSV file, or some other kind of file easily consumable by a lead purchaser. Excel® is a registered trademark of the Microsoft Corporation and refers to a commercially available spreadsheet editing software product and its associated file format.

In various embodiments, information about purchased leads is delivered to the user at remote lead purchasing device 112, as illustrated in FIG. 1. For example, this delivery may be made to the purchaser by directly distributing the information, such as by downloading the information to a device (such as a smartphone or a computer) of the purchaser, or may be emailed to the user using conventional email delivery, technology. In one embodiment, when leads are delivered by email, the user receives an email with a link to view the lead. In this embodiment, the lead is then available to view once without authentication. For subsequent views, the user needs to provide credential information. It should be appreciated that this mechanism ensures, in part, that multiple users do not surreptitiously view leads of other users and attempt to make first contact (or duplicative contact) with the individual identified by the lead.

In one embodiment, lead information is delivered by telephone to a sales person. For example, in an embodiment where a lead takes the form of an active telephone call, the disclosed system may utilize techniques currently used to perform “hot transfers” within a telephone system. For example, a hot transfer may occur when a non-sales individual is speaking with a person representing a potential lead, and transfers the potential lead directly to the sales person without any need for subsequent contact by the sales person. The term “hot transfer” may be used to describe such a transfer while the potential lead waits on the telephone. In this embodiment, the experience of the person representing the sales lead may be a seamless one—that is, the potential purchaser may not experience two separate, distinct telephone calls.

It should be appreciated, however, that the delivery of leads by the disclosed Lead Distribution System 302 is not limited to the mechanisms described and discussed with respect to FIG. 2. For example, leads may be delivered via a client software application stored on the remote lead purchasing device 112 (such as a smartphone “app”) and thus the lead delivery mechanisms described below may not be needed. In another embodiment, leads are delivered to a consumer by telephone, such as by transferring the consumer to a telephone call with the person represented by the lead.

In the flow diagram 300 illustrated in FIG. 2, a number of services are provided in conjunction with the disclosed Lead Distribution System 302. For example, address verification services are provided as illustrated in block 312. Provision of these services is performed in response to a request for address verification. Response to the request takes the form of either a validation or a rejection.

In one embodiment, the Lead Distribution System 302 determines whether to provide information, such as one or more leads, to an agent based on whether or not the address associated with the lead can be validated by block 312. It should be appreciated that this validation may be performed to ensure that the lead is legitimate and does not represent a fraudulent or illegitimate lead. In one embodiment, the Lead Distribution System 302 performs this check prior to delivering leads according to lead orders it is managing to ensure that the delivered leads carry with them a reasonable chance of resulting in a sale.

Similarly, the disclosed Lead Distribution System 302 may make a request for National Insurance Produce Register services, such as a request to validate a particular agent who desires to purchase or sell a lead. This request is illustrated in block 314. In response to such a request, the NIPR services block 314 returns either a validation or rejection of the agent for whom such validation was requested. The disclosed Lead Distribution System may use the received validation or rejection to determine whether to provide the purchased lead to the purchasing agent. Alternatively or in addition, the Lead Distribution System 302 may ask the NIRP services block to perform a validation at the time an agent places a lead order, to ensure that the lead order is legitimate and that the agent placing the order is, in fact, authorized to receive the lead information.

Block 316 illustrates the functionality of providing a credit card validation, such as validating a credit card with which an agent wishes to use to refill or reload his or her account with the Lead Distribution System 302. As illustrated by FIG. 2, in response to a request to validate a credit card, Credit Card Services block 316 responds with either a validation or rejection. In one embodiment, the request for validation includes a request to validate for a certain amount, such as a reload amount the user wishes to place in his purchasing account in the Lead Distribution System 302.

Upon receiving either the validation or rejection, the Lead Distribution System 302 determines whether to provide the purchaser's account with the requested amount of funds for use in fulfilling one or more lead orders placed by the purchaser. For example, if the credit card an agent is using to purchase leads is rejected by the credit Card Services block 316, the Lead Distribution System 302 in one embodiment determines not to reload the agent's account, and thus cannot provide leads according to any lead orders placed by the agent. Alternatively, if the credit card the agent is using is validated by the credit Card Services block 316, the Lead Distribution System 302 may charge the credit card and deposit the requested funds in the user's account, such that leads can continue to be delivered according to any lead orders being managed for that user by the Lead Distribution System 302.

Finally, the flow diagram 300 illustrated in FIG. 2 indicates that the Lead Distribution System 302 can communicate with an accounting system 318 to provide financial information to the accounting system. For example, the Lead Distribution System 302 may provide records of each purchase of leads, including an identification of the seller, the purchaser, the price, and the quantity of the leads, to the accounting system 318 for storage and later reporting.

It should be appreciated that in one embodiment, one or more of the services provided by the address verification service, the NIPR service, the credit card services, and the accounting system, represented by blocks 312, 314, 316, and 318, respectively, is incorporated within the Lead Distribution System 302. Thus, it should be appreciated that while in the illustrated embodiment the blocks of the flow diagram 300 represent distinct systems for performing distinct services, in other embodiments one or more of the functions illustrated by the blocks of FIG. 2 are performed within Lead Distribution System 302. For example, the Lead Distribution System 302 may be responsible for validating addresses of leads to ensure their legitimacy.

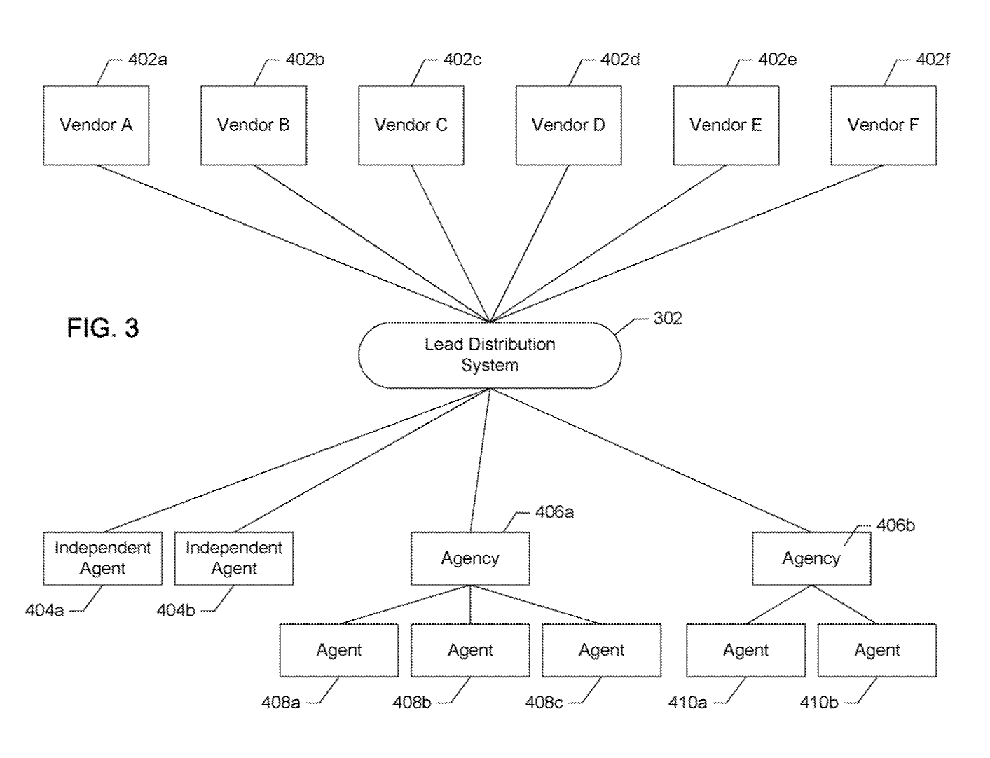

FIG. 3 illustrates an example of the architecture of lead vendors, sales agencies, and sales agents facilitated by the system disclosed herein. It should be noted that the architecture illustrated in FIG. 3 is exemplary, and in other embodiments the disclosed system is used to connect agents to vendors without the agents being affiliated or associated with agencies. Other architectures involving vendors, agencies, and/or agents are also contemplated as being facilitated by the disclosed system.

Referring to FIG. 3, the disclosed Lead Distribution System 302, as illustrated an explained with respect to FIG. 2, enables vendors to provide leads to a sales force of sales agents. As illustrated in FIG. 3, six different lead vendors, including Vendor A 402a, Vendor B 402b, Vendor C 402C, Vendor D 402d, Vendor E 402e, and Vendor F 402f, provide leads to Lead Distribution System 302. In this embodiment, each vendor utilizes one or more remote lead selling devices 110 to access the Lead Distribution System 302, and to make its leads available for purchase by any one of a number of agents. It should be appreciated that one or more of the vendors may operate according to the ping/post methodology described above, while one or more other vendors may operate by responding to requests made by the Lead Distribution System 302.

As also illustrated in FIG. 3, two independent agents 404a and 404b connect directly to the Lead Distribution System 302 to obtain leads provided by the plurality of vendors. That is, each of the independent agents 404a and 404b utilize a remote lead purchasing device 112 to access the Lead Distribution System 302, and can place lead orders to be filled (if possible) by any of the vendors also connected to the Lead Distribution System 302.

FIG. 3 illustrates the further architectural possibility with the disclosed system of enabling agencies, employing a plurality of salespeople, to access the Lead Distribution System 302. Specifically, FIG. 3 illustrates that two agencies, 406a and 406b, can access the Lead Distribution System 302, and that agents working for the agencies can thereby obtain leads sold by the plurality of lead vendors. In FIG. 3, agents 408a, 408b, and 408c can access Lead Distribution System 302 through Agency 406a, and agents 410a and 410b can access Lead Distribution System 302 through Agency 406b.

It should be appreciated that in one embodiment, the agencies themselves (or representatives thereof) purchase leads from vendors and distribute them to the agents. As will be discussed below, this functionality may be implemented by enabling a representative of the agency to specify a recipient of leads other than himself or herself in placing a lead order. In another embodiment, the agency enables its agents to directly access the Lead Distribution System 302, such that the agents can specify lead orders and purchase leads without the need to rely on their respective agencies.

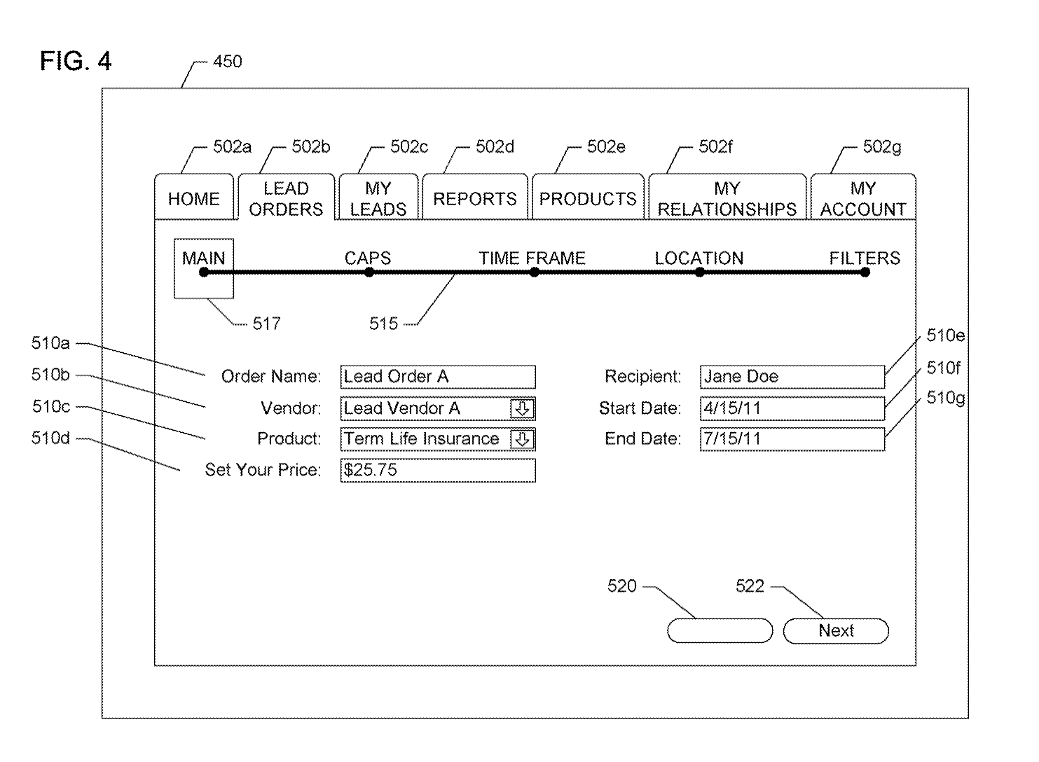

The foregoing description of FIGS. 1, 2, and 3 has focused on the architecture of the disclosed system, and the relationships between lead vendors and lead purchasers (or consumers) that can be established according to the disclosed system. FIGS. 4, 5, 6, 7, and 8 each present an exemplary schematic of a screen that is displayed to a purchaser of leads accessing the disclosed system wishing to place a lead order. For example, FIGS. 4, 5, 6, 7, and 8 in one embodiment are screen shots displayed to a purchaser of leads during the specification and placing of a lead order accessing the disclosed system from remote lead purchasing device 112.

The web sites and data used to display the following screen shots in one embodiment is stored in one or more databases 250 on a storage device 218 connected to the host device 108. It should be appreciated that in such an embodiment, the host device 108 is acting as a web server, enabling the user (such as an agent) to specify the constraints of a desired lead order, and to thus purchase leads from a plurality of vendors by interacting with a web page hosted by the web server.

FIG. 4 is a schematic illustration of an example screenshot of the user interface provided by the disclosed lead distribution system. Specifically, FIG. 4 illustrates an example screen 450 that is displayed by the host device 108 to a user at the remote lead purchasing device 112.

Screen 450 enables the user to select one of a plurality of tabs 502a, 502b, 502c, 502d, 502e, 502f, or 502g, each of which provides the user with the ability to perform different tasks within the disclosed system. The following discussion explains some of the tasks enabled by these tabs, but it should be appreciated that other tasks consistent with the disclosure contained herein could equally be enabled by the disclosed system.

In general, the disclosed system enables a user to click on one of the tabs 502a, 502b, 502c, 502d, 502e, 502f, or 502g to view a different set of information. In one embodiment, if the user selects the Home tab 502a, the system navigates to the user's buyer home page, which may provide an overview of the user's account and/or options of tasks to perform with the account. In one embodiment, the home screen includes one or more announcements provided by the Lead Distribution System 302, a vendor, or an agency with which the user is associated. In a further embodiment, the home screen includes a dashboard that may include certain summary information about the status of the user's account. For example, the dashboard may display an account balance, an indication of how many new leads have been received (if any), links to allow the user to adjust the amount of funds in his or her account, information about any pending Invitations, and/or information about any new subscriptions. For each or all of these pieces of information, the dashboard may provide links to enable the user to quickly navigate to the pertinent page within the system to, for example, view any new leads, pending invitations, or new subscriptions.

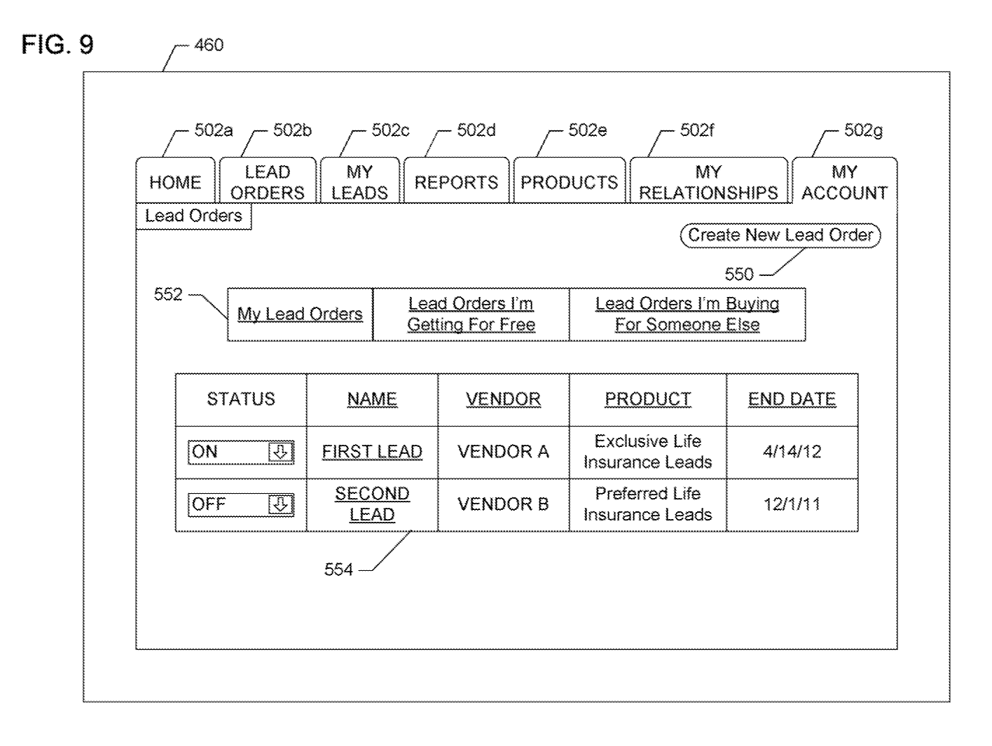

Selecting the Lead Orders tab 502b may navigate the user to a page that enables him or her to place a lead order or to modify an existing lead order. In one embodiment, selecting the Lead Orders tab 502b causes the disclosed system to display a user interface similar to that illustrated in FIG. 9 and discussed in detail below, which enables a user to view active lead orders and create new lead orders as desired.

Selecting the My Leads tab 502c may navigate the user to a page summarizing his or her lead orders, and any leads that presently reside in the user's account. Selecting the Reports tab 502d may provide the user with access to some of the reporting functionality enabled by the disclosed system. This reporting functionality is discussed in more detail below. Selecting the Products tab 502e enables the user to view the types of products for which leads can be provided. Selecting the My Relationships tab 502f enables the user to view any relationships that exist between the user and other users of the system and/or that exist between the user and one or more vendors. Finally, selecting the My Account tab 502g enables the user to access and modify details associated with his or her account, such as credit card information, email and postal address information, biographical information, and other appropriate account-related information.

In the embodiment illustrated in FIG. 4, the user has selected Lead Orders tab 502b, and has further indicated that he or she wishes to create a new lead order. The screen that enables the user to select such options is illustrated in FIG. 9 and is discussed in more detail below. As a result of the user's selection, the disclosed system causes screen 450 to be displayed, which enables the user to create and/or modify the parameters associated with an order for one or more leads.

In the embodiment illustrated in FIG. 4, screen 450 displays an area associated with a first step in the process of placing an order for bids. According to screen 450 of FIG. 4, the user can enter an order name 510a, a desired vendor 510b, and a product type 510c. Specifically, in the illustrated embodiment, the user has identified the lead order name of “Lead Order A,” has indicated the desire to purchase leads from “Lead Vendor A,” and has indicated the desire to purchase leads that indicate a desire to purchase “Term Life Insurance” products. In one embodiment, the user has the ability to enter whatever order name he or she desires. In one embodiment, however, the vendor 510b and product 510c are selectable from a list of available vendors and products, such as by using a pull-down menu as is well known. In a further embodiment, the product 510c is specific to whichever vendor 510b was selected, such as using the pull-down menu.

Field 510d enables a user to name his or her desired price to pay for leads according to the illustrated lead order. In the illustrated embodiment, the user has identified a desired price of $25.75 per lead. It should be appreciated that the disclosed system advantageously provides a marketplace in which a user can name the price he or she wants to pay for a lead. It should be further appreciated that this named price may be subject to acceptance by a lead vendor, but upon acceptance the lead vendor distributes the lead information to the purchaser. In this way, the disclosed system enables a user of the system to effectively bid on leads, such that the user can enter what he or she believes will be a price likely to be accepted, and can thereby obtain leads at a price identified by the user as opposed to the lead vendor.

It should further be appreciated that in some embodiments, certain vendors and/or certain products do not enable a user to name a desired price. Instead, for these products, the user must accept the price suggested or offered by the vendor if he or she wishes to buy leads from the in vendor. The details of these embodiments will be discussed in more detail below.

In the embodiment illustrated in FIG. 4, the disclosed system causes the display of a field 510e in which the user can enter the name of the recipient of the purchased leads. In the illustrated embodiment, the user has entered the name “Jane Doe” as the recipient of the leads. Based on this entry, “Jane Doe” will receive information associated with the leads, including the leads themselves, according to the illustrated lead order.

It should be appreciated that in one embodiment, the user is the consumer of the leads, and as such he or she enters his or her own name in the field 510e. For example, if the user's name is “Jane Doe,” the user in the illustrated embodiment will receive the leads for which the order is placed. In another embodiment, the user can enter a different recipient, such as an insurance agent without the authority to purchase leads, and the purchaser need not be a consumer of leads. It should thus be appreciated that the disclosed system enables the purchase and distribution of leads to a sales force, even if the members of the sales force are not actually using the system.

In an embodiment in which a person different from the user of the disclosed system has been identified as the recipient of the purchased leads, the disclosed system may present the user with a form enabling the user to create a customized invitation to the lead recipient. For example, the form may enable the user to enter a name and email address of the recipient, such that an automatically generated invitation email can be sent to the lead recipient. In a further embodiment, the system enables the user of the system to input a customized message indicating the reason for the lead purchase, a characteristic of the leads, or other suitable personalized message to be sent to the lead recipient.

In one embodiment, wherein the consumer of the leads whose name is provided in the form illustrated in FIG. 4 is different from the person who creates the illustrated lead order, the person receiving the leads is already registered with the disclosed system. In this embodiment, the invitation sent to the recipient of the leads merely indicates that the individual will be receiving leads. In another embodiment, the recipient of the leads is not registered with the disclosed system. In this embodiment, in addition to an indication that the person will be receiving leads, the invitation includes instructions for the recipient to create a new account and log in to the disclosed system. In this embodiment, leads are delivered through the disclosed system, such that the user needs to register and log in to receive leads. In still another embodiment, the disclosed system sends the consumer of leads an email indicating that the individual will be receiving leads, but does not instruct the individual to register with the disclosed system. In this embodiment, registration is not necessary as leads are delivered through a different mechanism than the disclosed system, such as by providing links or attachments to conventional email.

Fields 510f and 510g enable the user to input the desired start and end dates for the lead order. It should be appreciated that in one embodiment, the start and end dates can be further customized by providing a series of time frames during which the user wishes to receive leads, as is discussed in more detail below.

In the illustrated embodiment, the user has indicated a desire to purchase leads from Apr. 15, 2011 until Jul. 15, 2011. By providing a date range of desired lead purchasing, the disclosed system enables the user to effectively “subscribe” to a feed of lead information, such that any leads sold by Lead Vendor A for the Term Life Insurance product which the lead vendor is willing to sell for $25.75 will be purchased according to Order A and will be delivered to Jane Doe. Thus, the system enables the lead purchaser to place an order, the results of which will be delivered to Jane Doe over a three-month span.

In alternative embodiments, the disclosed system enables a user to purchase leads on a one-time basis, or allows a user to select which particular leads to purchase lead-by-lead, depending on the desired mechanism for user interaction. In such embodiments, the disclosed system may enable the user to view a plurality of individual leads presently offered for sale by one or more vendors, such as by viewing information about the particular product for which the lead is provided and/or the location of the individual represented by the lead. In this embodiment, the disclosed system further enables a user to select one or more particular leads to purchase, and upon purchase delivers the leads to the specified individual as discussed above.

In the illustrated embodiment, the screen displayed in FIG. 4 is the first in a series of screens that together enable the user to place an order for leads. Specifically, timeline indicator 515 indicates that the process of placing an order for leads includes a “main” screen, a “caps” screen, a “time frame” screen, a “location” screen, and a “filters” screen. It should be appreciated that the timeline indicator 515 is exemplary, and the instant system could be used to provide a process of purchasing leads or other intangible property with different steps or stages from those illustrated in FIG. 4.

Indicator 517 indicates that in the displayed screen of FIG. 4, the user is at the “main” screen in the lead purchase order process. As above, the indicator 517 illustrated in FIG. 4 is exemplary, and it should be appreciated that any appropriate indicating mechanism may be used to inform the user how far along he or she is through the process of purchasing intangible property such as leads.

As a result of the stage-by-stage process of purchasing leads in the illustrated embodiment, the system causes the display of two buttons 520 and 522. Buttons 520 and 522 enable the user to navigate through the series of lead order screens by moving either to the previous screen or to the next screen. In the illustrated embodiment, since the screen 500 is the first of the series, only the “Next” button 522 is active. In subsequent screens, which are not the first screen, it should be appreciated that a “Previous” button 520 is also activated, enabling the user to proceed forward or backward through the series of screens as desired. It should be appreciated that any suitable mechanism for proceeding through the various stages associated with placing an order for leads could be employed within the disclosed system.

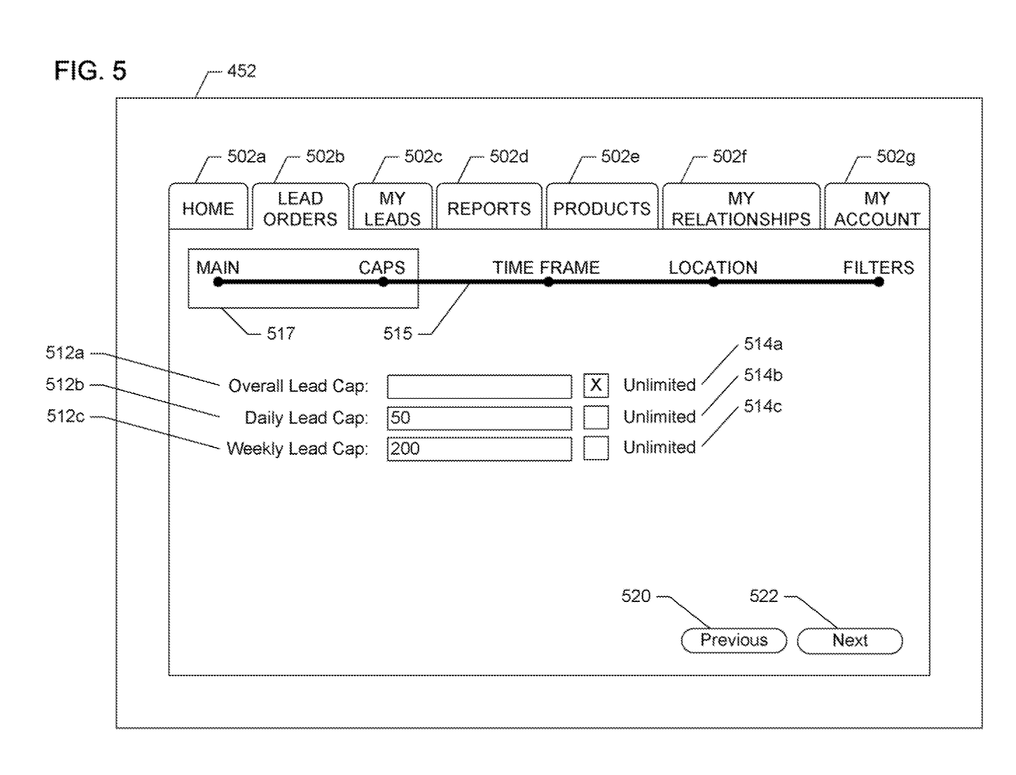

Referring now to FIG. 5, a screen shot 452 of the next step in one embodiment of the lead purchasing process is illustrated. As indicated by progress indicator 517, the step following the “main” screen is entitled “caps,” and enables a user to set caps in terms of amounts of leads delivered for daily, weekly, and overall lead purchasing activities. As illustrated in FIG. 5, field 512a enables a user to enter an overall lead-purchasing cap, which in one embodiment allows the user to put an overall cap on the purchase of leads according to a single order. In the illustrated embodiment, the lead purchasing cap is not time-restricted except inasmuch as a lead order according to the instant disclosure has a start date and an end date.

Field 512b enables the user to place a similar cap on daily lead purchases according to a single order, and field 512c allows the user to place a cap on the weekly purchased leads according to a single order.

In the illustrated embodiment, fields 514a, 514b, and 514c enable the user to indicate that no cap should be placed on the leads delivered according to an order over a given amount of time. In the embodiment illustrated in FIG. 5, the user has indicated that there should be no overall limit on the number of leads purchased according to Lead Order A, as evidenced by the “X” mark in field 514a. However, according to fields 512b and 512c, the user has indicated that the maximum number of leads purchased in a single day should be 50, and thee maximum number of leads purchased in a single week should be 200. In this embodiment, so long as the order is in effect, leads will be purchased until the fiftieth lead is purchased in a single day and until the two-hundredth lead is purchased in a single week.

As noted above, the screen shot in FIG. 5 illustrates the functionality, enabled by the disclosed system, which enables the user to select the “Next” button 522 to proceed to the next screen. It should be appreciated that since the screen illustrated in FIG. 5 is neither the first screen nor the last screen in the order process, the “Next” button 522 an the “Previous” button 520 are both activated, enabling the user to return to a previous step in the lead purchase process or to proceed to the next step.

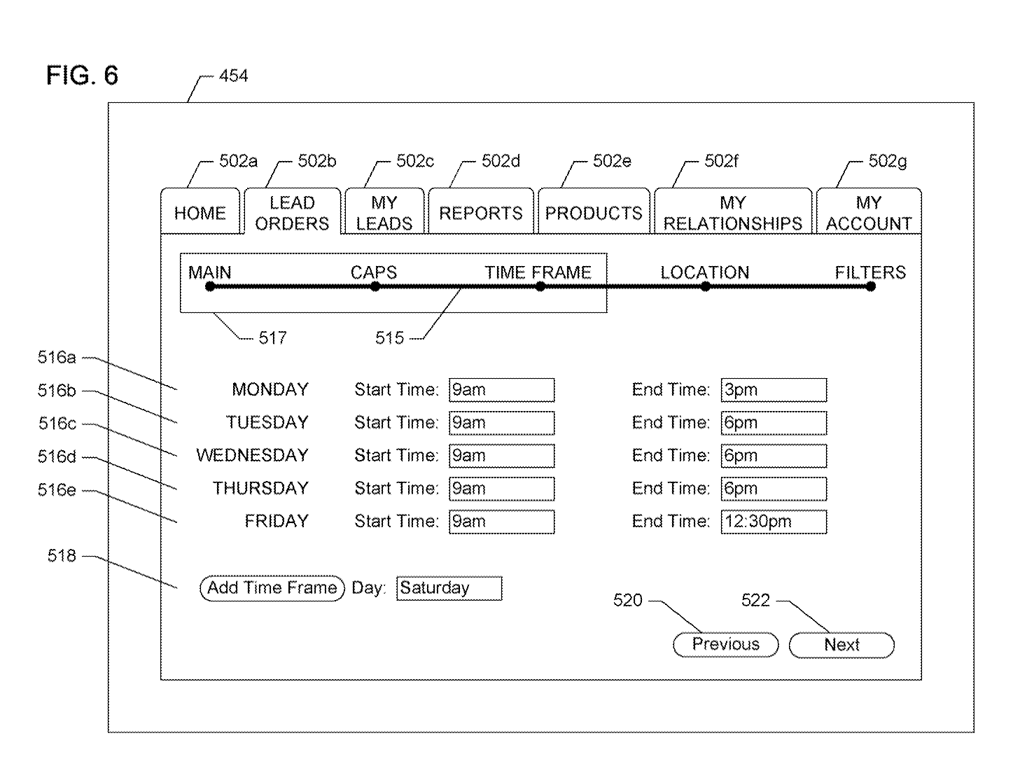

FIG. 6 illustrates a screen shot 454 of a subsequent screen in the process of purchasing leads. As illustrated by indicator 517, the screen displayed in FIG. 6 is the “Time Frame” screen, which follows the “Caps” screen in the process of purchasing leads. In the illustrated embodiment, the “Time Frame” screen enables a user to indicate a plurality of time frames during which he or she wishes to receive lead information. It should be appreciated that this specification of receipt times for purchased leads may provide further granularity than the begin date and end date for a particular lead order to be in effect as described above.

In the illustrated embodiment, a time frame has been specified for Monday through Friday. For each of the days specified, a start time of 9:00 am has been selected. In the illustrated embodiment, this selection means that the user will begin receiving leads, to the extent they are available in satisfaction of the order, at 9:00 am on Monday through Friday. For Tuesday, Wednesday, and Thursday, the user has specified that an end time of 6:00 pm is desired. Thus, on Tuesday, Wednesday, and Thursday, the user will receive leads from 9:00 am until 6:00 pm. On Monday, the user stops receiving leads at 3:00 pm. On Friday, the user stops receiving leads at 12:30 pm.

It should be appreciated that by entering appropriate time frame information data using fields 516a, 516b, 516c, 516d, and 516e, the user can identify the time frames during the course of a week during which he or she wishes to receive leads. Further, by selecting the Add Time Frame button 518, and by entering the desired day, the user can create additional rows of time frame data. For example, if the user wishes to specify a window of time on Saturday during which he or she would like to receive lead information, the user can select the Add Time Frame button 518, with the word “Saturday” entered in the appropriate field, and upon an additional row being displayed, can specify the desired time frame on Saturday.

In one embodiment, the “Time Frames” functionality enables a user to specify particulars of his or her schedule, such as a need to take every other Friday off of work, that are recurring in nature. In a further embodiment, the disclosed system enables a user to specify a vacation by specifying a particular date or range of dates during which he or she does not want to receive leads. In such an embodiment, after the passage of the specified date or range of dates, lead delivery resumes according to the specified time frames.

It should be appreciated that other mechanisms of entering time frames are contemplated and may be employed in the system herein. For example, time frames could be imported from a user's calendar program, could be manually entered in a text document, could be entered by picking a plurality of pre-determined options, or could be entered in any other desired way. The ability to enter time frames during which the user would like to receive leads, however, is an example of the type of flexibility the disclosed system can provide to its users. It should be appreciated that a user need not employ time frame limitations to specify the time of receipt of purchased leads. If no such time frames are specified, the user will receive each lead as it is purchased.

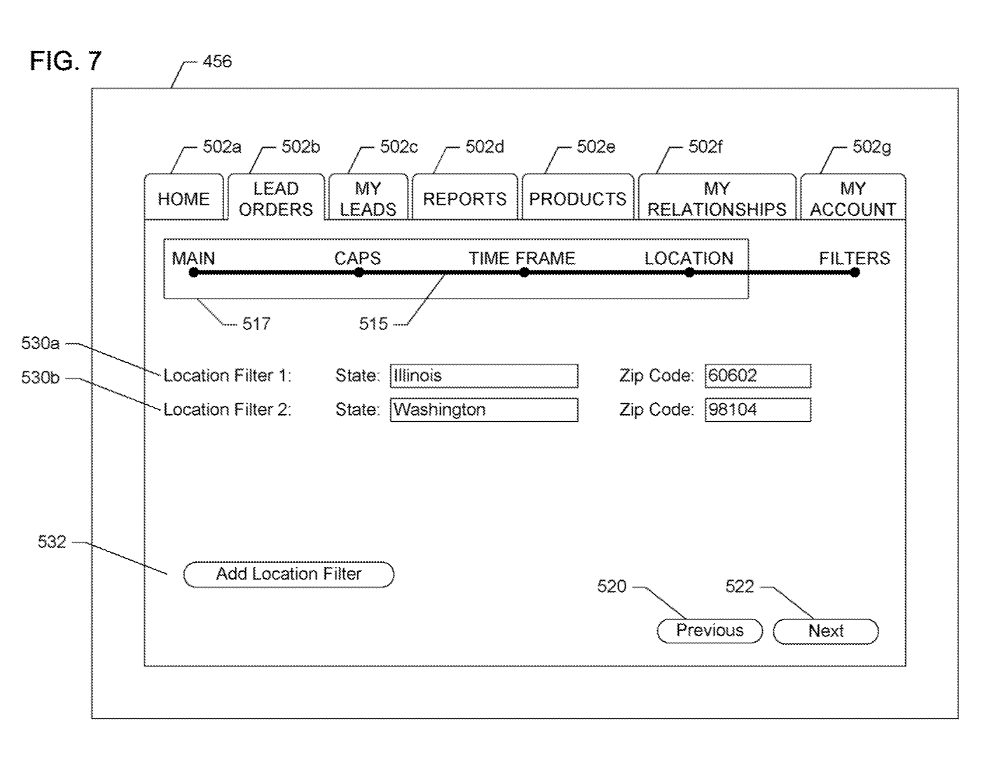

FIG. 7 illustrates a screen shot 456 of a location filter functionality that is enabled by the disclosed system in various embodiments. In the illustrated embodiment, one or more location filters can be created by selecting the “Add Location Filter” button 532. In the illustrated embodiment, two location filters, “Location Filter 1” and “Location Filter 2,” have already been created and are consequently displayed in the screen shot of FIG. 7. As indicated by field 530a, Location Filter 1 filters received leads such that only leads in Illinois, and specifically in Chicago, are provided according to the illustrated lead order. Similarly, field 530b indicates that due to Location Filter 2, leads will also be delivered if they are located in Seattle, Wash. In the illustrated embodiment, the user can enter either the state of interest, the zip code of interest, or both. It should be appreciated that a user need not employ location filters to filter the received data. If no such filters are specified, the user will receive each lead that falls within the specifications previously provided in the lead purchasing process.

In another embodiment, the user can specify the desired location for purchased leads by selecting a state and/or zip code from a drop-down menu, or can provide some other geographic indication of the bounds on desired leads.

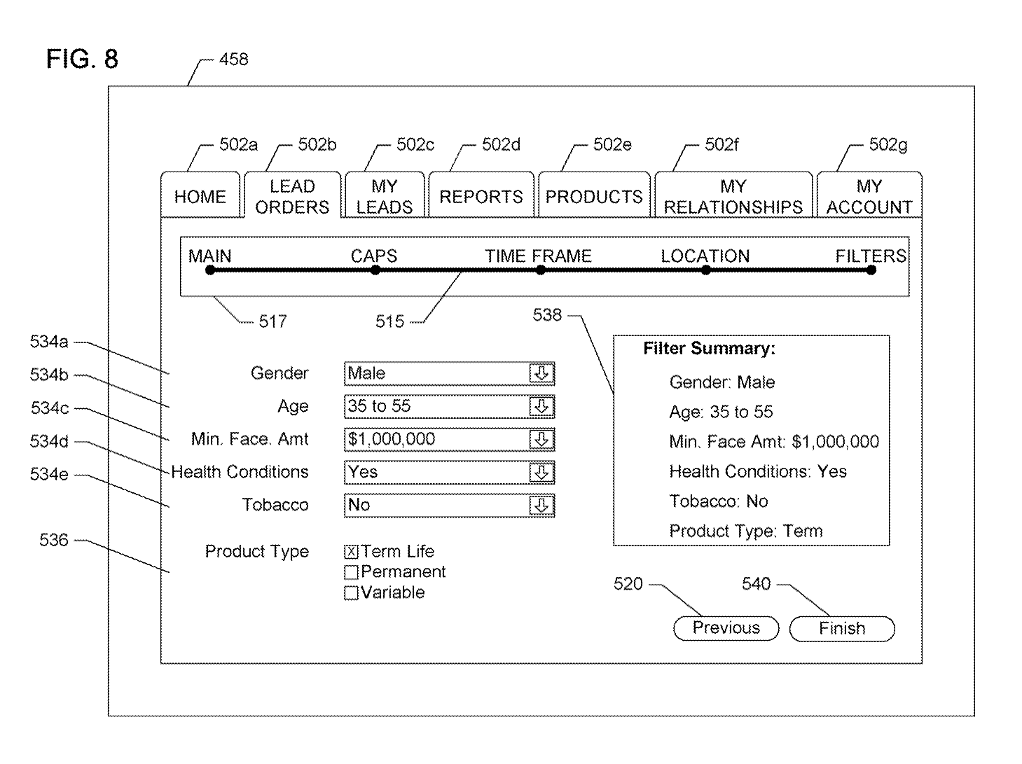

FIG. 8 illustrates a screen shot 458 of the final screen in the series of screens associated with placing an order for leads. In the illustrated screen shot, the indicator 517 indicates that the “Filters” stage is the last stage involved in placing an order for leads. The “Filters” stage enables a user to set one or more filters based on the substance of the leads to be purchased. For example, in the illustrated embodiment, a user can filter by gender, age, face amount of a desired insurance product, health conditions, and tobacco usage. By manipulating the pull-down boxes illustrated in fields 534a, 534b, 534c, 534d, and 534e, the user can select the exact combination of criteria he or she would like purchased leads to satisfy. In other embodiments, the fields by which a user can filter leads provided according to a lead order vary according to the fields present in some or all of the delivered leads.

In addition, field 536 enables the user to check one or more types of product for which he or she is interested in receiving leads. Based on the options selected in this field, the user will purchase only leads that are associated with the selected products. Area 538 displays a summary of the filter according to the selected options.

It should be appreciated that in one embodiment, by creating a filter as illustrated in FIG. 8, the disclosed system limits the leads it actually purchases according to whether those leads satisfy the specified filter. In another embodiment, the system purchases a plurality of leads and after purchasing the leads, applies users' filters to the purchased leads. In this embodiment, the leads are only delivered according to a lead order if the leads satisfy the specified filter.

As illustrated in FIG. 8, the “Next” button has been replaced by “Finish” button 540, such that when the user is finished creating a filter, the user can select the “Finish” button and place the order for leads. It should be appreciated that the “Previous” button still enables a user to proceed backward in the lead order process in the event the user wishes to change any of the options he or she previously selected.

In the embodiment illustrated by the screen shots of FIGS. 4, 5, 6, 7, and 8, the “Lead Orders” tab 502b enables the user to place an order for leads. It should be appreciated that in another embodiment, the “Lead Orders” tab 502b also enables the user to alter one or more pending lead orders, such as by altering the caps, the time frames, the locations, the filters, or any of the main criteria provided in the course of placing the lead order. In this embodiment, an interface similar to that illustrated in FIGS. 4, 5, 6, 7, and 8 is provided to the user, but which enables the user to alter an existing lead order.

For example, FIG. 9 illustrates a screen shot 460 of an example screen that enables a user to manage pending lead orders. The screen shot 460 illustrated in FIG. 9 is displayed upon the user selecting the “Lead Orders” tab 502b. In the illustration of the screen shot of FIG. 9, words within areas 552 and 554, which are illustrated with underlining, are links that a user can select with an appropriate input device such as a mouse.

In one embodiment, the screen shot 460 is the first screen displayed to a user upon selecting the “Lead Orders” tab 502b. In the illustrated embodiment, the screen 460 enables the user to manage the lead orders he or she has placed and is responsible for from a single, convenient interface. The illustrated screen also enables the user to create new lead orders as described above with respect to FIGS. 4, 5, 6, 7, and 8 by selecting the “Create New Lead Orders” button 550. In one embodiment, selecting button 550 links the user screen 450 of FIG. 4. The user can then proceed through the process described above with respect to FIGS. 4, 5, 6, 7, and 8, and can thereby create a new lead order.

In the illustrated embodiment, area 552 contains links that allow a user to manage orders he or she has placed by selecting the “My Lead Orders” link. In this embodiment, area 552 also enables the user to select the “Lead Orders I'm Getting For Free” link to manage lead orders for which the user is receiving leads, but for which the user is not paying. For example, the “Lead Orders I'm Getting For Free” link enables the user to alter certain characteristics of lead orders purchased by someone else (to the extent the disclosed system allows such alteration. Finally, the “Lead Orders I'm Buying For Someone Else” link enables the user to manage lead orders he or she has placed for another individual by writing the other individual's name in the “Recipient” area 510e of FIG. 4. In one embodiment, the user can alter all aspects of lead orders placed for another person.

In one embodiment, the interface for managing lead orders is similar wither the user selects “My Lead Orders,” “Lead Orders I'm Getting For Free,” or “Lead Orders I'm Buying For Someone Else” from area 552. In this embodiment, such an interface is displayed in area 554. Each row in area 554 (with the exception of a header row) displays information about a different lead order. By selecting the pull-down menu in the left-most column, labeled status, the user can turn a lead order on or off. By selecting the link associated with the name of each lead order, such as the link associated with the lead order entitled “FIRST LEAD,” the user can modify the order as described above with respect to FIGS. 4, 5, 6, 7, and 8. The remainder of the data displayed in the body of the table in area 554 is for the user's information, and is not selectable.

In one embodiment, if the user selects the link for “Lead Orders I'm Getting For Free,” the user is directed to a page summarizing the lead orders placed by another individual but identifying the user as the recipient of the leads. In one embodiment, the user cannot modify the preferences of such a lead. In another embodiment, the user can modify some but not all of the preferences of lead orders placed by other individuals, such as by modifying the desired time frames as discussed above.

Area 554 further enables a user to sort data in the table by selecting one of the links associated with one of the columns of data. For example, if the user wishes to sort lead order data by name, the user can select the “Name” link in area 554.

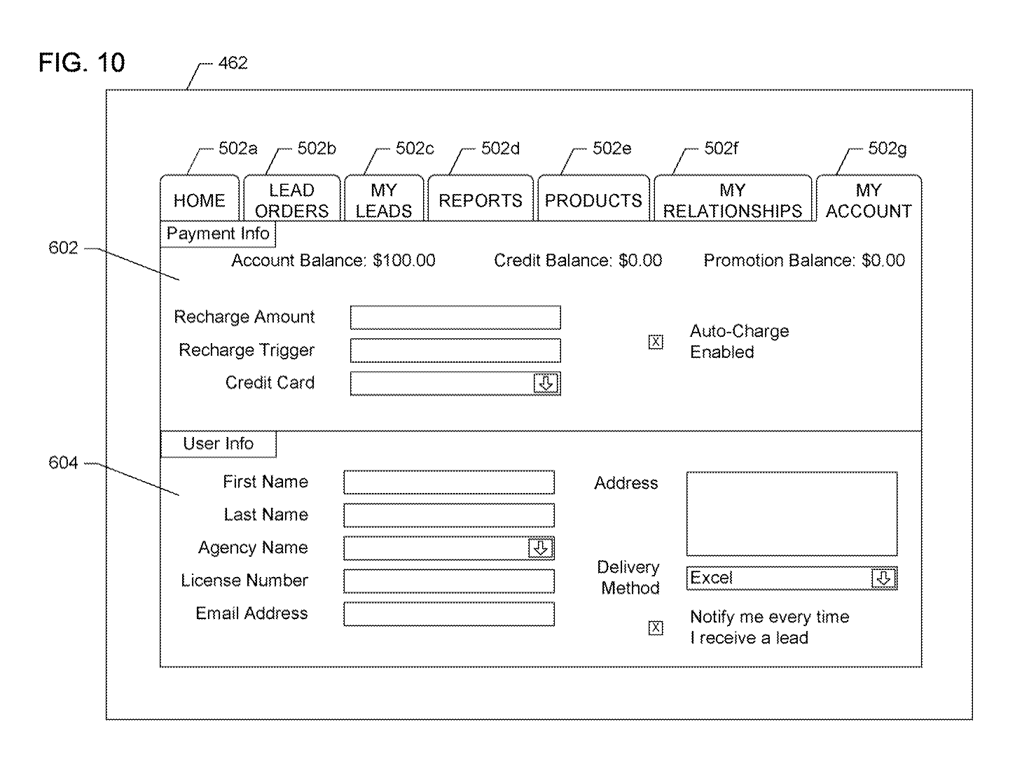

FIG. 10 illustrates a screen shot 462 provided by the disclosed system when a user at remote purchasing device 112 selects the “My Account” tab 502g. In the illustrated embodiment, selecting the “My Account” tab 502g causes the disclosed system to display information about the account associated with the user. Specifically, the system may display an area 602 that includes payment information. In the illustrated embodiment, area 602 displays payment information such as the user's present account balance, the user's credit balance, and the user's promotion balance. In one embodiment, the account balance reflects an amount of funds available in the account based on credit card transactions authorized by the user. In one embodiment, the credit balance reflects an amount of funds available based on credits provided to the user either by a lead vendor or other entity in the course of the utilization of the disclosed system. For example, credits may be accrued in the event a user requests a refund for a duplicative or otherwise useless lead. In one embodiment, the promotion balance reflects an amount of funds made available to the user as a promotion, such as based on one of the lead vendors providing promotional funds in an effort to generate interest in its leads.

In the illustrated embodiment, payment info area 602 also enables the user to specify a recharge amount and a recharge trigger, such that when the account balance reaches the recharge trigger, the recharge amount is charged to the user's credit card and placed into the account. The payment info area 602 also enables the user to indicate a credit card to be used to recharge the account. Finally, a checkbox labeled “Auto-Charge Enabled” allows the user to specify whether he or she would like to be asked to authorize each charge to the indicated credit card. Selecting the checkbox results in the system automatically charging the indicated credit card when the recharge trigger is hit. As discussed above, validation of the user's credit card may occur by way of credit card services provided by an external system.

Area 604 of the screen illustrated in FIG. 10 enables the user to enter personal information about him or herself. For example, the user can provide a name, address, agency name, email address, and the like. Likewise, area 604 enables the user to provide information particular to the type of leads purchased. In the illustrated embodiment, the “agency name” field is accessed by way of a pull-down menu. This may enable the system to verify that the user works for an agency that is affiliated with or authorized to use the system. As further illustrated in FIG. 10, the user can provide his or her insurance sales license number. In one embodiment, the disclosed system uses this information to request NIRP services, as discussed above with respect to FIG. 2, to validate that the purchaser is authorized to purchase sales leads.

The area 604 may also enable the user to select delivery options relating to the mechanism by which leads are delivered. For example, as illustrated in FIG. 10, the system enables the user to select a Delivery Method for the leads by selecting a pull-down menu item. In the illustrated embodiment, the selected method is “Excel,” meaning that the user has opted to receive lead information as Microsoft Excel® spreadsheet files. In some embodiments, the pull-down menu allows the user to select CSV, or comma-separated values, as a delivery option, or other suitable options for delivery.

Finally, the disclosed system enables the user to check a box, displayed in user info area 604, indicating that the user would like to receive a notification every time he or she receives a lead.

It should be appreciated that the above discussion of one embodiment of an interface for purchasing leads is merely exemplary, and describes one specific interface with which a user can interact to specify which leads he or she wishes to purchase. In other embodiments, other fields are provided, or the existing fields are provided in a different order, to allow users wishing to purchase leads to specify different characteristics and features of the leads to be purchased.

As discussed above, the disclosed system may be used in one embodiment to purchase leads for delivery to a consumer of the leads who is different from the purchaser of the leads. In this embodiment, the process of ordering leads is similar to the process described above, and the “Recipient” field 510e of screen 450 of FIG. 4 populated with lead consumer's name which is different than the person purchasing the leads.

In one embodiment, a lead as discussed herein is embodied in a computer-readable file or collection of data that includes certain information necessary to form the lead. For example, a lead may be a file encoded with an XML schema having a number of fields. For example, a lead may include fields related to an offer request for an exclusive distribution, an offer request for a shared distribution, an offer response, a delivery request, a delivery response, and/or lead details. The fields may include data indicating vendor IDs, demographic information about the prospect such as location, gender, requested face amount, age, whether the prospect has health conditions, and whether the prospect uses tobacco. In one embodiment, this information is insufficient to identify the individual represented by the lead, and thus is sent as part of the request and response messages prior to purchase of the lead. Lead information may also include a number of legs, which in one embodiment represents the number of times the disclosed system can sell the lead, and a number of legs sold, which in one embodiment represents the number of times the lead has been sold.

Upon selling the lead, the vendor may provide more specific demographic information, such as name, address, telephone number, date of birth, email address, IP address, type of product the prospect wishes to buy, and/or a unique identification number given to the lead by the vendor. This information enables the sales person, who is in receipt of the purchased lead, to contact and attempt to sell products to the individual. The lead may include further information, such as the county of the prospect, the best time to reach the prospect, an indication of whether the prospect is insured, an indication of whether the prospect takes medication and details of such medication, an indication of whether the prospect is pregnant, an indication of whether the prospect has HIV or another disease, an indication of whether the prospect has any alcohol additions, an indication of whether the prospect has Alzheimer's disease, and indications of whether the prospect has numerous other health-related conditions. In an embodiment, the lead may also indicate the prospect's occupation and whether that occupation is hazardous or whether the prospect engages in hazardous activity, such as whether the prospect is a pilot. Finally, the lead may include other information about the prospect, such as information about criminal activity, height and weight of the prospect, or information about whether the prospect has ever declared bankruptcy.

In an embodiment, the disclosed system enables the purchaser of the leads to alter or amend the order in a way similar to that described above, notwithstanding the fact that the leads are being delivered to a different individual. In one embodiment, the disclosed system enables the recipient of the leads to alter some or all of the criteria associated with the lead order. For example, the recipient of the leads may be able to alter every field of the lead order. In another embodiment, the lead recipient can only alter a subset of the fields, such as the “Time Frame” fields, but cannot alter other fields, such as the “Set Your Price” field.

The disclosed system may also enable a reward system to sales people by enabling a party wishing to incentivize activity by sales people to cause the disclosed system to provide leads to the sales people without charge to the sales people. In one embodiment, the ability to specify a recipient different from the person who places the lead order enables this functionality.

For example, if a sales person makes a requisite number of sales in a month, the disclosed system may enable a product provider such as an insurance company for whom a sales person is selling insurance policies to distribute or otherwise cause the disclosed system to distribute a designated quantity of leads to that sales person without charge to the sales person. These leads may be provided at no cost to the provider of the incentive (e.g., the insurance company) or, alternately, the product provider such as the insurance company may have to pay for the leads and the leads simply may be provided at no cost to the sales person. Alternatively, if a sales person purchases a requisite number of leads in a month (i.e., regardless of whether the leads result in sales), the disclosed system may reward him or her with additional leads at no charge. In one embodiment, the disclosed system enables this distribution of sales leads to any customer or consumer of leads on behalf of (and potentially paid for by) any other entity.

The disclosed system may enable a community of sales people to be established, and may advantageously enable networking through that community. This too may be facilitated by the ability to enter a different recipient of leads than the individual purchasing the leads. For example, a supervisor of a sales person may monitor sales activity of that sales person, and may reward that sales person with leads (either provided without cost or paid for by the supervisor) according to the sales activity. Moreover, leads may be exchanged within the community established by the disclosed system, such that overall sales are maximized.

In one embodiment, the disclosed system enables users of the system and/or recipients of the leads purchased through the disclosed system to advantageously form relationships with one another. In one embodiment, these relationships enable the formation of a social networking system, such as by enabling users of the system to interact with one another and exchange leads with one another.

In one embodiment, the system disclosed herein enables a user to view a summary of his or her relationships. For example, the system may display a page that enables the user to view a summary of individuals he or she is receiving leads from, buying leads for, has sent invitations to, and has received invitations from. In an embodiment, this page enables the user to add a new relationship, such as by sending an invitation to a different person, or to delete an existing relationship. If the user deletes a relationship, the system may automatically turn off lead orders associated with that relationship.

In one embodiment, the social networking environment facilitated by the disclosed system enables one user to bestow one or more purchased leads on another user. For example, the disclosed system may enable an agency representative to reward its customers (i.e., its agents or agencies) for sales activities by making deposits into their accounts for future purchase of sales leads. In a further embodiment, rather than making deposits into the accounts of agents, the disclosed system enables users to transfer purchased leads into the accounts of other users (or non-users, such as non-user agents) as a reward for past sales activities. In various embodiments, these rewards or incentives are provided in exchange for an individual achieving a predetermined sales goal, such as in exchange for an individual converting a designated percentage of leads into sales or the individual making sales amounting to a designated value.

In one embodiment, not illustrated above, the user of the disclosed system is presented with a “Terms and Conditions” screen at some point during the lead order process. For example, the timeline 515 may include an additional point, between the “Main” and “Caps” points, at which a “Terms and Conditions” screen is displayed. In an embodiment, in order to complete the lead order process, the “Terms and Conditions” screen must be viewed and/or accepted. In one such embodiment, acceptance of the terms and conditions indicate an intent to be bound by the offer to purchase leads.

In another embodiment, acceptance of the terms and conditions requires acceptance of certain lead replacement conditions. For example, the disclosed system may provide the purchaser of leads with replacement leads in the event (a) the telephone number of the lead is not working, (b) the identified lead is fictitious or non-living, (c) the person identified in the lead is under 18 years of age (or some other age), or (d) the lead is a duplicate of a previously purchased lead. In one embodiment, acceptance of the terms and conditions thus indicates acceptance of a displayed lead replacement policy, in which leads satisfying the criteria above are replaced with legitimate leads. It should be appreciated that this replacement policy may prevent a user of the disclosed system from purchasing a lead for which there is no chance of consummating a sale, rendering the lead valueless.

In one embodiment, the disclosed system includes a mechanism for a user to request a replacement lead. This mechanism may facilitate requests for replacement according to an accepted lead replacement policy. For example, a web form may be displayed to the user, which enables the user to indicate that a duplicate or otherwise inoperative lead has been received. In one embodiment, the web form enables the user to select one of the reasons, (a) to (d), described above, without specifying more information about which lead was inoperative. In another embodiment, the form is launched by selecting an appropriate button associated with the inoperative lead, and information about the inoperative lead is embedded within the form, such that the system can track which leads are inoperative. In one embodiment, the web form includes a field, which enables a user to enter a “Lead ID,” such that upon submitting the form the faulty lead can be located, tracked, and removed from the disclosed system. The web form may further provide a field for the user to indicate the provider of the lead, the user's name, the sales person's name, or any other information about the lead or its attempted use that for obtaining a replacement.

In one embodiment, in which the vendor system can ping the Lead Distribution System 302 with an indication that a lead is available, the Lead Distribution System 302 responds with one but preferably a plurality of lead order matches. Within the matches, the Lead Distribution System may specify that the lead will be exclusive such that the vendor knows not to re-distribute the lead.

In one embodiment, if the Lead Distribution System 302 disclosed herein is operating on a ping/post model with a particular vendor, the system does not abide by any expiration time for a response to a post. That is, if a vendor posts the availability of a lead, the disclosed system can respond at any time. In another embodiment, an expiration time may be associated with one or more posted leads, such that if the disclosed system does not respond quickly enough, the vendor may withdraw the posting and resell the lead elsewhere.

In one embodiment, the Lead Distribution System 302 may have a plurality of criteria on which it may reject a posted lead following the provision of a lead order match. For example, the Lead Distribution System 302 may reject one or more posted leads on the following grounds:
(a) The posted lead is a duplicate with a previously posted lead;
(b) The address associated with the lead was not validated, or the validation of the address resulted in an error,
(c) The buyer for whom the lead order match was provided met his or her lead cap;
(d) The buyer for whom the lead order match was provided has insufficient funds to purchase the lead;
(e) The lead is posted outside the valid timeframes identified by the buyer;
(f) The lead order for which the match was provided has been turned off;
(g) The provided lead was an exclusive lead, and therefore cannot be resold; and/or
(h) The lead, while nonexclusive, has hit a resell maximum level.

It should be appreciated that many of these criteria are defined by the user of the system in the course of defining a lead order. For example, if the user specifies a time frame for receiving leads and the lead posted outside that timeframe, the Lead Distribution System 302 may reject that lead. It should be further appreciated that the ability to reject leads ensures that the users' lead purchasing criteria are satisfied to the extent possible.

In one embodiment, the system further improves the quality of leads provided to the purchasers of the leads by providing duplicate lead checking across multiple vendors, and by providing real-time lead validation, such as by validating the address or telephone number associated with a lead. In one embodiment, the system also rejects delayed leads, and ensures that leads are delivered according to lead orders and the associated filters. The system also enables a limited lead distribution model wherein leads are sold only to one agent with a pre-set affiliate relationship, such as within a pre-set affiliate company.

In one embodiment, as a part of the ping response to the lead order match message sent by the Lead Distribution System 302, the vendor indicates that the lead is going to be provided only to the disclosed Lead Distribution System 302. Alternatively or in addition, the ping response from the lead vendor may identify which companies and/or agents the lead has been previously been provided to, and may also identify a maximum number of times the lead was sold.

In one embodiment, the disclosed system enables users who wish to purchase leads from lead vendors to learn more about the lead vendors and their lead offerings prior to placing an order for leads. In one embodiment, this benefit is achieved by enable the users of the system (i.e., the lead purchasers) to easily link to information about each lead vendor, such that the user can be confident in placing lead orders from specific enumerated lead vendors.

In one embodiment, the disclosed system enables the lead vendors to place desired or absolute prices on the leads they are selling. In such an embodiment, the user has the option to accept the, lead vendor's price or not. In another embodiment, such as the embodiment discussed above, the disclosed system enables users of the system wishing to purchase leads to specify a desired price. In such a scenario, the system then facilitates the establishment of an offer/acceptance situation in which the lead vendor accepts the offer of the user or declines an offer of the user, depending on the goals of the vendor. In one embodiment, the lead vendor sets an initial or desired price, and the user purchasing leads can elect to either accept the offer, or to make a bid by proposing an alternative price for the leads. If the user presents a bid for an alternative price, the disclosed system communicates that bid to the lead vendor and the lead vendor has the option to accept or not to accept the offer.

In various embodiments, the auction-based bidding model (i.e., where the user indicates a price he or she would like to pay) enables users to purchase leads at a desired price, and enable the price to reflect the true market value of the leads.

In one embodiment, the disclosed system provides a feedback mechanism by which users can provide feedback as to the quality of purchased leads. This feedback mechanism may be a web form that allows users to enter information about the user's experience with a particular lead vendor. In one embodiment, the feedback is entirely subjective. For example, the feedback may consist entirely of user narrative about the quality of the lead. In another embodiment, the feedback is entirely objective. For example, the feedback may be objective data about the outcome of the lead. In yet another embodiment, the feedback can be a combination of subjective and objective feedback.

In one embodiment, based on objective feedback, the system provides information to future users on the quality of leads provided by a particular lead vendor. For example, if a user indicates a particular success rate of leads provided by a particular vendor, the system may make that information available to future users. Moreover, the system may aggregate feedback from a plurality of users, such that aggregate data is provided indicating the quality of a lead vendor. In one embodiment, one or more of the screen shots, such as those illustrated in FIGS. 4, 5, 6, 7, and 8, include an option to designate a particular criteria for a lead order based on user feedback about a lead vendor. For example, a user may specify that he or she only wishes to purchase leads from a lead vendor whose success ratio is over a designated frequency. It should be appreciated that various feedback mechanisms, and corresponding filter options, may be employed by the system disclosed herein.

In one embodiment, the disclosed system includes a probability scoring function that enables the system to suggest a calculate market price for leads. For example, if leads from a particular vendor are successful (i.e., result in a sale) 3.0% of the time, and the average sale is worth $2000.00 to the seller, the system may calculate an average market price for leads from that vendor to be $60.00. In one embodiment, the system automatically provides this calculated price as an offer in the event the offering price from the lead vendor is higher than the calculated market price. In one embodiment, if the calculated market price is higher than the offered price, the system does not provide a bid different from the offer price. In a further embodiment, the system causes an alert to be pushed to its users if a calculated market price is higher than a lead offer price, as such a situation may indicate that purchasing leads from a particular vendor is a good value proposition.

In one embodiment, the ability to predict the performance of a particular set of leads is referred to as “business intelligence.” In an embodiment, the disclosed system can use the disclosed business intelligence to calculate a score representing the relative strength of a potential lead order. This score may be based on probability of a sale as calculated from past performance, and may further be based on a disease, disorder, age, state, gender, average premium amount, and the like. As an example, the business intelligence may enable the system to provide information such as the following: leads from a particular vendor that represent males age 40 or older that have type 2 diabetes result in sales 25% of the time with an average annual premium of $800.00. Thus, the system determines that leads of this type have an approximate value of $200.00. If the leads can consequently be obtained for less than $200.00, the system's business intelligence suggests that such a purchase is a good investment. Other business intelligence, such as intelligence on which vendors leads are the most valuable, the time frames during which the delivery of leads is the most lucrative, and other appropriate predictors of future success selling to individuals reflected in sales leads, is contemplated herein.

As discussed above, the disclosed system in some embodiments provides mechanisms for guaranteeing that duplicate leads are not provided to a user. For example, leads to be provided to a user may be cross-referenced against leads provided by the same vendor or different vendors based, for example, on telephone number or address, to ensure that duplicate leads are avoided. In one embodiment, if a user receives a duplicate lead, the user can user the above-discussed credit form to request a credit for the duplicate lead.

The disclosed system may include reporting capabilities that enable a user to compare various features of lead orders place in the past with one another and with contemplated lead orders to be placed. In one embodiment, for example, the system enables a user to compile a Return on Investment report, in which the system calculates and displays return on investment for one or more lead purchases or for one or more lead orders. For example, the system may calculate return on investment by calculating the number of dollars worth of products sold based on contacts made from leads of a specific lead order. In one embodiment, return on investment is displayed as a ratio of contacts made (or leads purchased) to sales made.

The reporting capabilities of the disclosed system may also include the ability to calculate Lead to Sales Ratios, which in one embodiment are presented to the user as a percentage indicating the frequency of a purchased lead resulting in a sale of product. In one embodiment, lead to sale ratios are calculated based on whether any sale is made at all. In another embodiment, lead to sale ratios are calculated based on whether the product with which the lead was associated was sold, and may also be presented based on whether another, different product was sold.

In one embodiment, the disclosed system enables the creation of cumulative reports by vendor, by product, or by other desired parameters useful to ascertaining the success of vendors, leads, and/or sales people. Other reporting capabilities of the disclosed system may include the ability to calculate and display representations of demographic trends, vendor trends, spending trends, and other kind of trend information. In various embodiments, this trend information is displayed in graph or chart form, and plots performance indicators, such as number of leads purchased, number of sales made, number of sales of a particular product, and other appropriate measurements are displayed over the course of a period of time. In still other embodiments, other reporting capabilities are included within the disclosed system to enable its users to reliably analyze the performance of the leads delivered through the disclosed system.

In one embodiment, the disclosed system provides a standard interface that enables partners to easily interact with the disclosed system. For example, the disclosed system may provide lead vendors with a standardized form for presenting lead information, such that if the vendor uses the standardized form, the disclosed system can automatically and easily decode the information in the form for pushing to the lead purchasers. In a further embodiment, the standardized form is a web form available from a website provided to the vendors, such that the vendors' systems can easily interact with the disclosed system without substantial modification.

In one embodiment, the disclosed system provides vendors with substantial advantages to increase revenue through advertisement and cross-selling. For example, in one embodiment the system disclosed herein enables vendors to indicate similarities between products it sells. In this embodiment, after a user of the disclosed system submits a lead order, the system provides the user with a page that displays additional product offerings that may be of interest to the user. For example, if a vendor believes that one of its products is a useful complement or substitute for another of its products, the system may display an indication to the user that he or she may be interested in the additional products. In one embodiment, this feature is available to vendors only if they utilize a standardized lead submission form.

The disclosed system may display a real-time quote for an intangible product, such as an insurance product, based on information entered by the person. Alternatively, the system may display other pertinent advertisements to the individual at the time he or she enters his or her information. Thus, it should be appreciated that the system disclosed herein may enable the display of information to a person representing a potential lead at the time that person provides information to the system.

In one embodiment, the disclosed system enables insurance advertisers (such as licensed agents or insurance carriers) with an opportunity to bid on quote results. If an advertiser is authorized to sponsor a quote result (appointed to that product), the advertiser will pay when the person clicks to view that particular quote. In this way, the system enables the collection of revenue from advertisers upon users clicking on a quote for insurance. Similarly, the disclosed system enables insurance advertisers to bid for exit pop-ups from insurance websites. In one embodiment, vendors using the standardized form for providing quote information can earn additional revenue by allowing the disclosed system to pop-up the website of the highest bidder at the point the customer is leaving the lead generation process. In one embodiment, wherein advertising revenue is collected from insurance advertisers, vendors that submit leads to the disclosed system are paid a percentage of the received advertising revenue.

In various embodiments, the disclosed system pushes advertisements to one or more people indicated by the leads being offered for sale. In another embodiment, the disclosed system pushes advertisements to one or more agents who purchase and/or consume leads. In this embodiment, the advertisements indicate products that the agent can sell to his or her customers, such that the advertisements drive further sales by agents to purchasers.

In one embodiment, the disclosed system enables one or more providers of a product (such as an insurance carrier) to sponsor one or more leads. This sponsorship may only apply for leads that meet certain parameters (e.g., leads for individuals who are between the ages of 40-50, male, and are looking for between $250,000 and $500,000 in coverage). In one such embodiment, the sponsor of the lead (such as the carrier) would provide some of the funds to purchase the lead. In exchange, the disclosed system would send an email directly to the lead, which email may contain a quote for insurance and a link to an online multimedia advertisement. In a further embodiment, the sponsor of the lead may receive a list of the agents and consumers for which purchased a portion of a lead. This list enables the carrier to call the agent to determine whether the person represented by the lead purchased the sponsors product.

To this end, in one embodiment the disclosed system sends one or more communications directly to the person represented by a lead. For example, as discussed above, the system may send an email to a lead including a quote, an advertisement, or other information about a potential purchased product. In one example, the system indicates to a sales person that such a communication has been sent, and thus enables the sales person to intelligently follow up on the previously-sent information.

In one embodiment, the system disclosed herein enables a vendor of leads to contract directly with an entity controlling the disclosed system to place its advertisements within various screens displayed or generated by the disclosed system. For example, the entity responsible for hosting the system on its web servers may provide a form to a lead vendor wishing to sell its leads. This form may include a link to an advertisement database, such that when an individual finishes filling out the form, an insurance carrier-sponsored advertisement may be displayed to that individual based on the information contained in the form. For example, if an individual indicates that he is a sixty-five year old male wishing to purchase automobile insurance, an automobile insurance carriers advertisement may be displayed to the individual through the disclosed system upon the individual completing the form.

The system disclosed and discussed herein may also display an advertisement to a consumer of the information generated and distributed by the system. For instance, after an insurance agent makes contact with an individual represented by a lead distributed to the agent via the system disclosed herein, the insurance agent may use the system (or some other system) to request a quote for insurance. In this example, the system enables an insurance carrier to purchase advertising space on the form sent to the agent in response to his or her request for a quote, such that upon receiving the response to the request for a quote, the agent is also presented with the carrier's advertisement. Like the situation described above, the system may be configured to tailor the advertisement to the agent based on the data included in the agent's request for quote. For example, if the agent requests a quote for an automobile insurance policy, an automobile insurance carrier's advertisement may be displayed to the agent.

One advantage of the system disclosed herein is that it enables a lead buyer to manage all of his or her lead buying activities through a single system, including managing the purchasing, delivery to themselves or others, payment, and return/credit request for bad leads. The system further advantageously enables the users to access leads available from multiple lead sources in a convenient, non-duplicative way. In one embodiment, the ability to provide leads across multiple vendors is further enhanced by the ability to provide access to the disclosed system in a co-branded fashion, such that a user experiences a consistent interface and does not feel as if he or she is purchasing leads from multiple disparate sources.

As a further byproduct of the integrated nature of the disclosed system, a user only needs to provide his or her credit card information a single time. The disclosed system handles the transfer of funds to the individual lead vendors, such that credit card information distribution is restricted and the users are protected.

Still further, the integrated system disclosed herein enables an agency with a plurality of agents working for it to track the activity of its agents. For example, the system enables the agency to track the number of leads pushed to its agents and the success of the agent based on those leads. Further, the system enables the agency to compare the agent's performance against the average reported performance for leads from a particular vendor, thus enabling the agency to detect agents who may be underperforming.

The disclosed system therefore beneficially enables buyers to sell and receive leads (even those leads which the user has not purchased him or herself) from a single account and via a single interface. Moreover, the purchase of leads is a single financial transaction, as the disclosed system charges the user's credit card and places funds in the user's account, but does not require the user to provide his or her credit card to each seller of leads. Finally, the integrated system advantageously enables a single interface for handling credits from all lead vendors, rather than requiring a purchaser of leads to contact each individual lead vendor to request credits or replacement leads.

The instant disclosure provides numerous advantages to both buyers and sellers of sales leads. From the perspective of the buyers of leads, the disclosed system advantageously provides real time and continuous (i.e., 24/7) access to both exclusive and shared leads. Moreover, the disclosed system provides access to leads from multiple vendors in a single platform. The system enables all lead buyers to access niche lead providers, and provides control over all facets of lead ordering and accenting. The quality control features discussed above also reduce lead waste and improve lead utilization and the percentage of leads that develop into sales. Finally, the system offers transparency to the lead buyers in terms of which vendors sell leads, and in terms of the specific lead vendors' return policies and forms.

The instant system offers substantial advantages to sellers of lead as well. Specifically, the disclosed system provides a single point of access to a large agent population, and provides this access without sales and support responsibility for the vendor. The system facilitates better utilization of lead inventory, and also enables the value of the leads sold by a vendor to be dictated by market demand. As a result, the system enables better monetization and utilization of undersold and unsold leads. It also provides vendors with a quantifiable incentive to improve the quality of their leads, in that the effectiveness of a vendor's relatively ineffective leads will be visible to the lead purchasers. Finally, the bid model enables for price fluctuation, and allows the price paid for leads to reflect the quality and demand for a vendor's leads.

The above description of is exemplary of the features of the system disclosed herein. As noted, the disclosed system could be used to sell any type of information to any type of purchaser of information, and is not limited to selling sales leads. Moreover, the functionality of the above-described system is not limited to the functionalities indicated herein. It should be understood that various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information distribution system comprising:
at least one processor;
at least one network interface device; and
at least one memory device which stores a plurality of instructions which, when executed by the at least one processor, cause the at least one processor to operate with the at least one network interface device to:
(a) enable a plurality of vendors of information to provide an indication of information for sale;
(b) enable at least one of a plurality of potential purchasers of information to provide at least one input indicative of a desired subset of the offered information;
(c) determine whether the information for sale satisfies the at least one input indicative of the desired subset; and
(d) if the determination is that the information for sale satisfies the at least one input indicative of the desired subset, provide the portion of the information to the at least one of the plurality of potential purchasers.

2. The information distribution system of claim 1, wherein the offered information includes a plurality of sales leads.

3. The information distribution system of claim 2, wherein at least one of the plurality of sales leads is an insurance sales lead.

4. The information distribution system of claim 1, wherein the plurality of instructions cause the at least one processor to determine whether the information for sale satisfies the at least one input indicative of the desired subset by comparing a user-indicated price with a vendor-supplied price.

5. The information distribution system of claim 1, wherein the plurality of instructions cause the at least one processor to determine whether the information for sale satisfies the at least one input indicative of the desired subset by determining whether a user-indicated product is reflected in the information for sale.

6. The information distribution system of claim 1, wherein if the determination is that the information for sale does not satisfy the at least one input indicative of the desired subset, the plurality of instructions cause the at least one processor to cause a client device to display a comparison between the information for sale and the at least one input.

7. The information distribution system of claim 6, wherein the comparison includes an offer to purchase alternative information.

8. The information distribution system of claim 1, wherein the at least one input includes at least one web form indicating a standing order for information.

9. The information distribution system of claim 1, wherein the plurality of instructions cause the at least one processor to send the information for sale to a different individual than a first individual who provided the at least one input.

10. The information distribution system of claim 1, wherein the plurality of instructions cause the at least one processor to request validation of the information for sale from at least one external system.

11. The information distribution system of claim 1, wherein the plurality of instructions cause the at least one processor to maintain an account balance usable to purchase information for sale from any of the plurality of vendors.

12. The information distribution system of claim 1, wherein the plurality of instructions cause the at least one processor to provide the portion of the information to an individual other than the purchaser of that information as an incentive to the individual.

13. The information distribution system of claim 12, wherein the purchaser of the information is at least one of an agency and a provider of a product related to the information, and wherein the individual is a sales person of the product related to the information.

14. A method of selling information, said method comprising:
(a) enabling a plurality of vendors of information to provide an indication of information for sale using at least one input mechanism;
(b) enabling at least one of a plurality of potential purchasers of information to provide at least one input indicative of a desired subset of the offered information;
(c) causing at least one processor to determine whether the information for sale satisfies the at least one input indicative of the desired subset; and
(d) if the determination is that the information for sale satisfies the at least one input indicative of the desired subset, causing the at least one processor to provide the portion of the information to the at least one of the plurality of potential purchasers.

15. The method of claim 14, wherein the offered information includes a plurality of sales leads.

16. The method of claim 15, wherein at least one of the plurality of sales leads is an insurance sales lead.

17. The method of claim 14, which includes causing the at least one processor to determine whether the information for sale satisfies the at least one input indicative of the desired subset by comparing a user-indicated price with a vendor-supplied price.

18. The method of claim 14, which includes causing the at least one processor to determine whether the information for sale satisfies the at least one input indicative of the desired subset by determining whether a user-indicated product is reflected in the information for sale.

19. The method of claim 14, which includes, if the determination is that the information for sale does not satisfy the at least one input indicative of the desired subset, causing the at least one processor to cause a client device to display a comparison between the information for sale and the at least one input.

20. The method of claim 19, wherein the comparison includes an offer to purchase alternative information.

21. The method of claim 14, wherein the at least one input mechanism includes at least one web form indicating a standing order for information.

22. The method of claim 14, which includes causing the at least one processor to send the information for sale to a different individual than a first individual who provided the at least one input.

23. The method of claim 14, which includes causing the at least one processor to request validation of the information for sale from at least one external system.

24. The method of claim 14, which includes causing the at least one processor to maintain an account balance usable to purchase information for sale from any of the plurality of vendors.

25. The method of claim 14, which includes providing the portion of the information to an individual other than the purchaser of that information as an incentive to the individual.

26. The method of claim 25, wherein the purchaser of the information is at least one of an agency and a provider of a product related to the information, and wherein the individual is a sales person of the product related to the information.

27. An information distribution system comprising:
at least one processor;
at least one network interface device; and
at least one memory device which stores a plurality of instructions which, when executed by the at least one processor, cause the at least one processor to operate with the at least one network interface device to:
(a) enable a plurality of vendors of information to provide an indication of a desired sale price of each of a plurality of pieces of information;
(b) enable a potential purchaser of information to provide at least one input indicative of a desired purchase price for information and a desired time frame for delivery of information; and
(c) for each of the plurality of pieces of information:
(i) determine if a vendor provision time for that piece of information is within the desired time frame for delivery,
(ii) determine if the desired sale price of that piece of information is less than the desired purchase price,
(iii) if the determination is that the vendor provision time for that piece of information is within the desired time frame for delivery and that the desired sale price of that piece of information is less than the desired purchase price:
A. debit an account of the potential purchaser by the sale price and
B. provide that piece of information to the potential purchaser, and
(iv) if the determination is that the vendor provision time for that piece of information is within the desired time frame for delivery but that the desired sale price of that piece of information is greater than the desired purchase price,
A. offer the desired purchase price to the at least one vendor providing said piece of information,
B. receive an indication of whether the at least one vendor accepts the offer at the desired purchase price, and
C. provide said piece of information to the potential purchaser if the at least one vendor accepts the offer at the desired purchase price.
